(19) United States
(12) Patent Application Publication
(10) Pub. No.: US 2026/0241596 A1
(43) Pub. Date: Aug. 20, 2026

(54) FOOD CUTTING DEVICE

(71) Applicant: Lingqiu Shen, Ningbo (CN)

(72) Inventor: Lingqiu Shen, Ningbo (CN)

(21) Appl. No.: 19/541,562

(22) Filed: Feb. 17, 2026

(30) Foreign Application Priority Data
Feb. 17, 2025 (CN) 202520250156.9
Feb. 17, 2025 (CN) 202520250160.5
Feb. 17, 2025 (CN) 202520250966.4
Dec. 1, 2025 (CN) 202522553333.3
Dec. 1, 2025 (CN) 202522553352.6

(51) Int. Cl. B26D 3/28; A47J 43/046; B26D 1/00; B26D 7/26

(52) U.S. Cl. CPC B26D 3/283; A47J 43/046; B26D 1/0006; B26D 7/2635; B26D 2003/288; B26D 2210/02

(57) ABSTRACT

A food cutting device includes a housing, a carriage, a first blade holder and a second blade holder each movable in a thickness direction of the carriage, a first drive shaft fixed to the first blade holder and having a first drive pin, a second drive shaft fixed to the second blade holder and having a second drive pin, and a first knob rotatably mounted on the carriage. The first knob includes a cam track. The first blade holder carries first blades on spaced first protrusions. The second blade holder carries second blades on spaced second protrusions that interleave with the first protrusions. The cam track is shaped to position the first drive pin and the second drive pin at different horizontal levels, whereby rotation of the first knob moves the first blades and the second blades asynchronously in the thickness direction.

### RELATED APPLICATIONS

This application claims the benefit of priority to Chinese Patent Application Number 202520250156.9, 202520250160.5, and 202520250966.4 filed on February 17, 2025, and Chinese Patent Application Number 202522553333.3 and 202522553352.6 filed on December 1, 2025, in the China National Intellectual Property Administration.

### TECHNICAL FIELD

The present disclosure relates to the field of food cutters, specifically to a food cutting device.

### BACKGROUND ART

Numerous patents exist relating to food cutting device for slicing or shredding food items such as potatoes. For example, Chinese Utility Model Patent No. ZL201821293309.4 (Publication No. CN208629506U) discloses a food cutting device comprising a first blade holder and a second blade holder. In the patent, the first blade holder and the second blade holder are operated independently via two separate threaded rods. This independent operation is inconvenient.

In another example, Chinese Utility Model Patent No. ZL202020608724.5 (Publication No. CN211993100U) discloses an easily adjustable food cutting device. In the patent, it requires two gears with special structural designs to move a cutting plate (blade holder). The specially designed gears are difficult to manufacture.

### BRIEF DESCRIPTION OF DRAWINGS

To illustrate technical features in embodiments of the present disclosure more clearly, the following briefly introduces accompanying drawings used in the description of the embodiments. Obviously, the accompanying drawings in the following description are only some embodiments of the present disclosure. Those of ordinary skill in the art can obtain other accompanying drawings from these accompanying drawings without any creative efforts.

FIG. 1 is a perspective view of a food cutting device according to Embodiment 1 of the present disclosure.

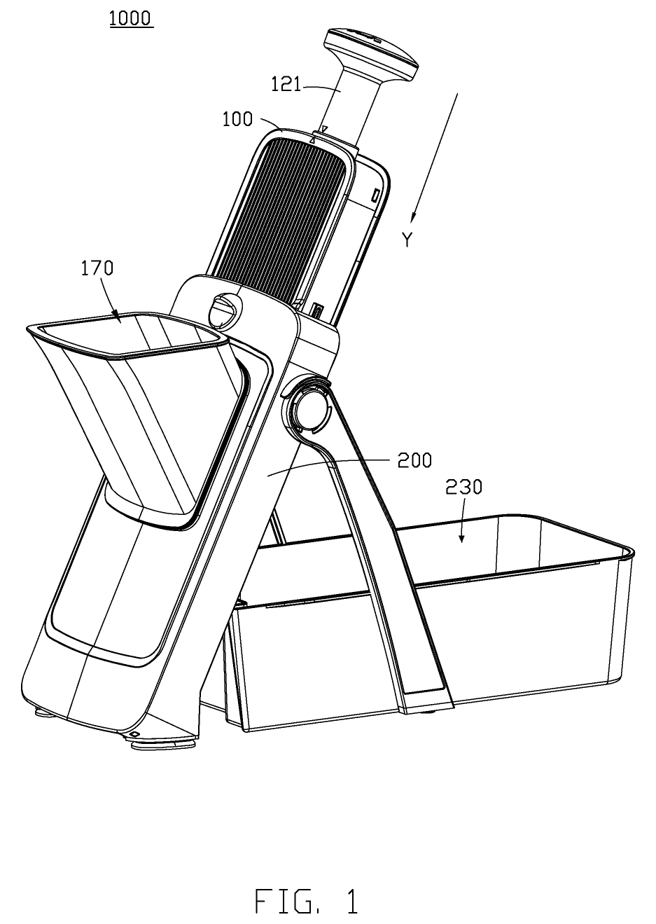

FIG. 2 is a schematic diagram of a cutting mechanism according to Embodiment 1 of the present disclosure.

FIG. 3 is an exploded view of the cutting mechanism according to Embodiment 1 of the present disclosure.

FIG. 4 is a side view of the cutting mechanism according to Embodiment 1 of the present disclosure.

FIG. 5 is a structural schematic diagram of a first blade holder and a second blade holder according to Embodiment 1 of the present disclosure.

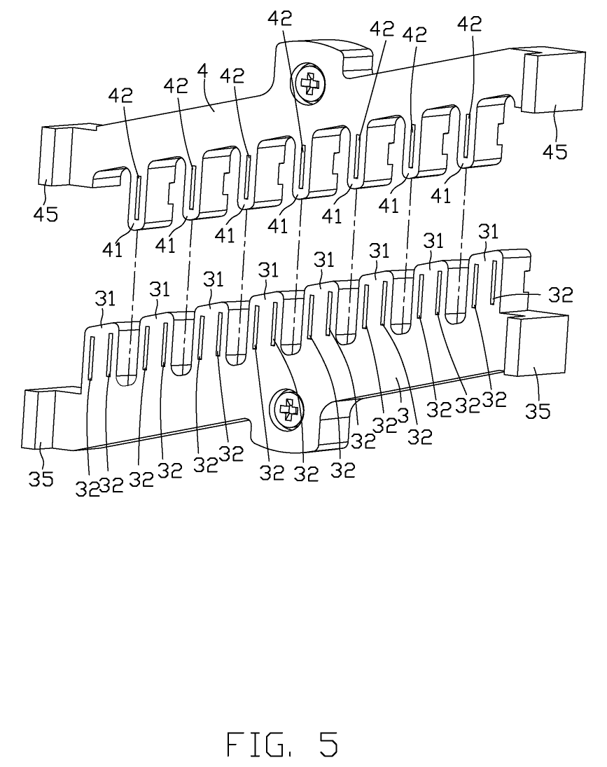

FIG. 6 is a structural schematic diagram of blades on the first blade holder and the second blade holder according to Embodiment 1 of the present disclosure.

FIG. 7 is a schematic diagram showing a state after the first blade holder and the second blade holder are assembled together according to Embodiment 1 of the present disclosure.

FIG. 8 is an exploded view of an adjustment mechanism for the second cutting blade of the food cutting device according to Embodiment 1 of the present disclosure.

FIG. 9 is a schematic diagram showing an installation structure between a drive shaft and a rib of the carriage of the food cutting device according to Embodiment 1 of the present disclosure.

FIG. 10 is a schematic diagram showing the positions of a first mounting portion and a second mounting portion in a first gear state.

FIG. 11 is a schematic diagram showing positions of the first mounting portion and the second mounting portion in a second gear state.

FIG. 12 is a schematic diagram showing a positional relationship between the first mounting portion and the second mounting portion in a third gear state.

FIG. 13 is a structural schematic diagram of a first knob according to Embodiment 1 of the present disclosure.

FIG. 14 is a structural schematic diagram of the first knob, viewed from another angle according to Embodiment 1 of the present disclosure.

FIG. 15 is a half cross-sectional schematic diagram of the first knob in the first gear state according to Embodiment 1 of the present disclosure.

FIG. 16 is a half cross-sectional schematic diagram of the first knob in the second gear state according to Embodiment 1 of the present disclosure.

FIG. 17 is a half cross-sectional schematic diagram of the first knob in the third gear state according to Embodiment 1 of the present disclosure.

FIG. 18 is an exploded view of a drive assembly according to Embodiment 1 of the present disclosure.

FIG. 19 is an exploded view of the drive assembly, viewed from another perspective according to Embodiment 1 of the present disclosure.

FIG. 20 is a schematic diagram showing an installation structure of a click pin according to Embodiment 1 of the present disclosure.

FIG. 21 is an exploded view of an adjustment mechanism for the second cutting blade according to Embodiment 2 of the present disclosure.

FIG. 22 is a structural schematic diagram of a transmission column according to Embodiment 2 of the present disclosure.

FIG. 23 is a structural schematic diagram of the transmission column, viewed from another angle according to Embodiment 2 of the present disclosure.

FIG. 24 is a half cross-sectional schematic diagram of the first knob in the first gear state according to Embodiment 2 of the present disclosure.

FIG. 25 is a half cross-sectional schematic diagram of the first knob in the second gear state according to Embodiment 2 of the present disclosure.

FIG. 26 is a half cross-sectional schematic diagram of the first knob in the third gear state according to Embodiment 2 of the present disclosure.

### DETAILED DESCRIPTION

Reference will now be made in detail to representative embodiments illustrated in the accompanying drawings. It should be understood that the following descriptions are not intended to limit the embodiments to one preferred implementation. To the contrary, the described embodiments are intended to cover alternatives, modifications, and equivalents as can be included within the spirit and scope of the disclosure and as defined by the appended claims.

### Embodiment 1

As shown in FIG_{S}. 1-19, a food cutting device 1000 of this embodiment includes a housing 200 and a cutting mechanism 400. The cutting mechanism 400 includes a carriage 100. A first cutting blade 103 is fixedly located on the carriage 100. The cutting edge of the first cutting blade 103 extends along the width direction (X direction) of the carriage 100. A first blade holder 3 and a second blade holder 4 are located on the carriage 100 and are movable relative to the carriage 100 in the thickness direction (Z direction). The first blade holder 3 and the second blade holder 4 are adjacently arranged. Blades are fixedly located on both the first blade holder 3 and the second blade holder 4, spaced apart along the width direction of the carriage 100. The blade surfaces of these blades extend along the thickness direction of the carriage 100. Moreover, these blades on the first blade holder 3 and the second blade holder 4 constitute a second cutting blade 190 of the food cutting device 1000.

The carriage 100 is slidably fitted relative to the housing 200. Furthermore, a push-pull portion 121 is detachably located on the carriage 100. By pushing the push-pull portion 121 along the cutting direction (Y direction), the carriage 100 can slide relative to the housing 200 in the Y direction. A feed tube 170 for placing food items to be cut is also located on the housing 200. Moreover, a reset elastic member is located between the housing 200 and the carriage 100 for driving the carriage 100 to slide upward (reverse to the Y direction) and reset after cutting. Cut food is collected by a collection tray 230.

Specifically, the first blade holder 3 has a plurality of first protrusions 31 arranged at intervals. Each first protrusion 31 is provided with two first insertion slots 32 for inserting first blades 33. The first blades 33 arranged on the first blade holder 3 form a first blade set 34. The second blade holder 4 has a plurality of second protrusions 41 arranged at intervals. The second protrusions 41 and the first protrusions 31 are mutually interleaved and fitted, and the first blade holder 3 and the second blade holder 4 are capable of relative sliding in the Z direction. Each second protrusion 41 is provided with one second insertion slot 42 for inserting a second blade 43. The second blades 43 arranged on the second blade holder 4 form a second blade set 44. The first blades 33 and the second blades 43 are parallel to each other, and the blades in the second cutting blade 190 are equidistantly distributed, ensuring uniform thickness of the cut shredded food.

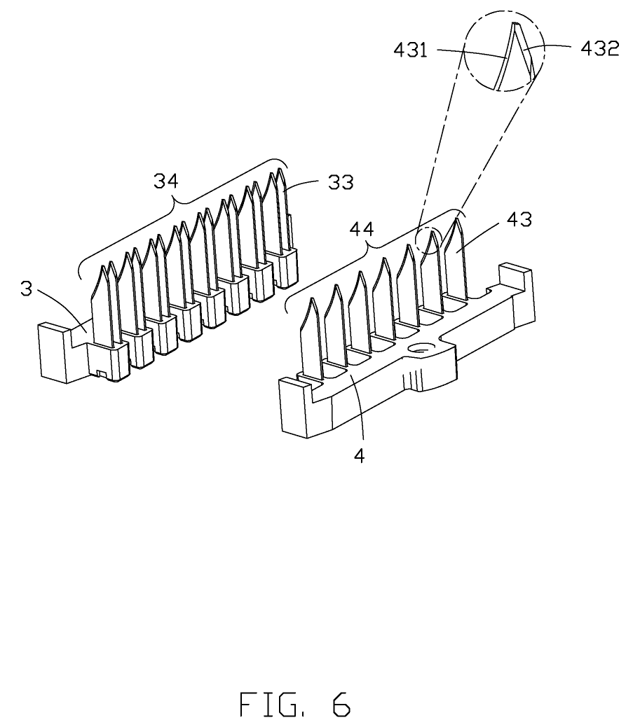

In this embodiment, referring to FIG. 6, the second cutting blade 190 has cutting edges on both the front and rear sides. The length of the front cutting edge 431 of each blade of the second cutting blade 190 in the Z direction is greater than the length of its rear cutting edge 432 in the Z direction. Herein, the side of the second cutting blade 190 facing away from the first cutting blade 103 is the front side, and the side close to the first cutting blade 103 is the rear side. The double-sided cutting edge design reduces the return resistance of the second cutting blade 190, allowing the second cutting blade 190 to smoothly retreat backward after cutting food forward in the Y direction. To adequately cut food, the front cutting edge 431 of the second cutting blade 190 has a larger length in the Z direction; for the rear cutting edge 432 of the blade, it is only necessary to ensure the presence of a cutting edge on the portion above the upper surface of the first cutting blade 103. Thus, its Z-direction length is smaller, which does not affect the strength of the front cutting edge 431 and facilitates the processing of the rear cutting edge 432 of the second cutting blade 190.

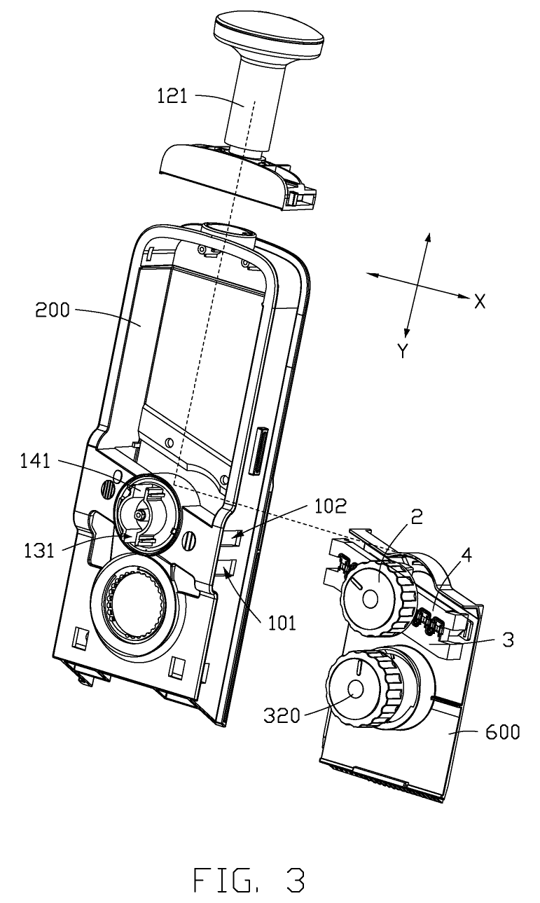

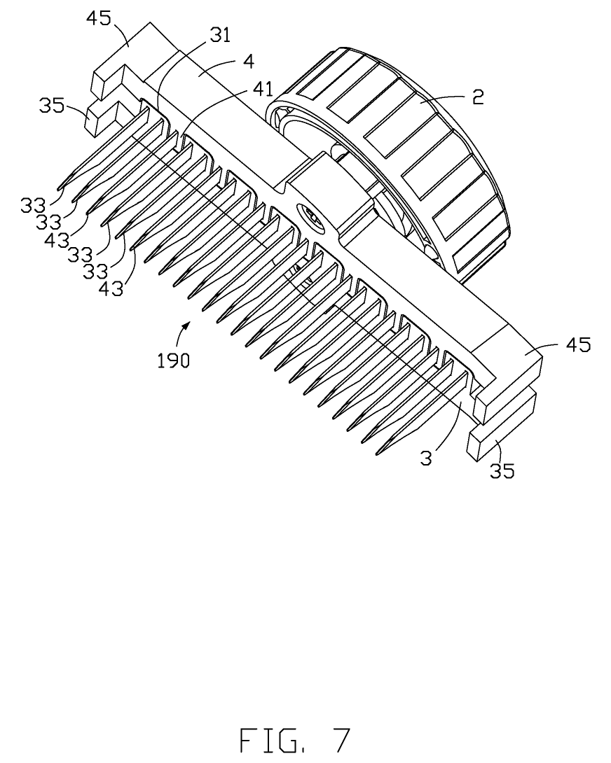

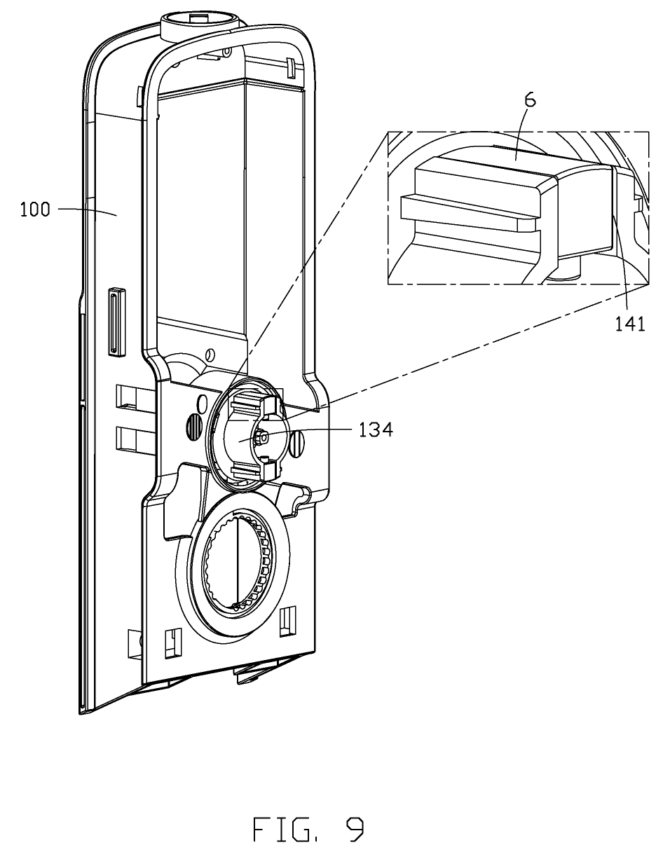

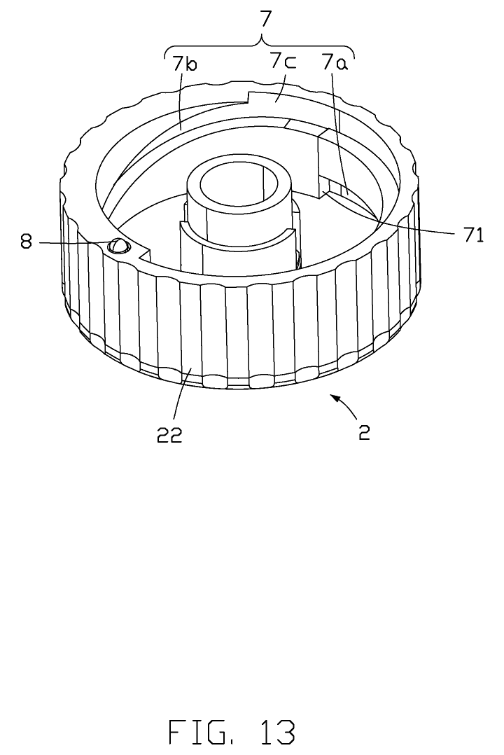

In this embodiment, referring to FIGS. 3-4 and 7-9, the carriage 100 further includes a first knob 2, a first drive shaft 5, and a second drive shaft 6. A protruding first drive pin 51 is provided on a side surface of the first drive shaft 5, and a protruding second drive pin 61 is provided on a side surface of the second drive shaft 6. The first knob 2 is rotatably mounted on the carriage 100. Referring to FIGS. 13-17, the first knob 2 is provided with a cam track 7. The first drive pin 51 and the second drive pin 61 are located in the cam track 7 and are both slidably engaged with the cam track 7. The first drive pin 51 and the second drive pin 61 are configured to extend substantially radially relative to the first knob 2. The first drive shaft 5 and the second drive shaft 6 are constrained on the carriage 100 and are movable along the thickness direction of the carriage 100. The shape of the cam track 7 is configured such that there is a state where the first drive pin 51 and the second drive pin 61 are not simultaneously located at the same horizontal level in the cam track 7, thereby enabling the first blades 33 and the second blades 43 to move asynchronously along the thickness direction of the carriage 100 when the first knob 2 is rotated. In this embodiment, the connection structure between the first knob 2 and the first blade holder 3 and the second blade holder 4 constitutes an adjustment mechanism 500 for adjusting the position of the second cutting blade 190 in the thickness direction of the carriage 100. The first drive pin 51 and the second drive pin 61 serve as followers of the cam track 7, converting rotation of the first knob 2 into linear movement of the respective drive shafts along the thickness direction of the carriage 100.

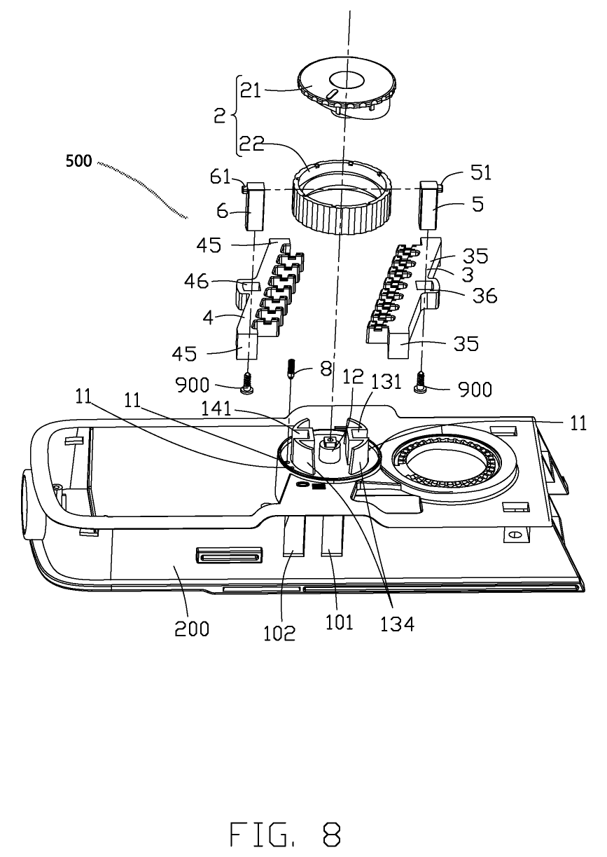

In this embodiment, referring to FIGS. 8-9 and 15-17, the first drive shaft 5 and the second drive shaft 6 are oppositely arranged and have a substantially rectangular cross-section. Referring to FIG. 8, the carriage 100 is further provided with a rib 134. The rib 134 is provided with a first rectangular hole 131. The first drive shaft 5 can be constrained within the first rectangular hole 131 and slide along the thickness direction of the carriage 100. The rib 134 of the carriage 100 is also provided with a second rectangular hole 141. The second drive shaft 6 can be constrained within the second rectangular hole 141 and slide along the thickness direction of the carriage 100. The first blade holder 3 is fixed to the lower end of the first drive shaft 5, and the second blade holder 4 is fixed to the lower end of the second drive shaft 6. Both opposite sides of the carriage 100 are provided with first mounting holes 101 and second mounting holes 102. The first mounting hole 101 and the second mounting hole 102 located on the same side are adjacently arranged. Both ends of the first blade holder 3 are provided with first mounting portions 35. The first mounting portions 35 are located within the first mounting holes 101 and can be constrained therein to slide along the thickness direction of the carriage 100. Both ends of the second blade holder 4 are provided with second mounting portions 45. The second mounting portions 45 are located within the second mounting holes 102 and can be constrained therein to slide along the thickness direction of the carriage 100.

When the first knob 2 is rotated, the first drive pin 51 and the second drive pin 61 can slide along the cam track 7. Consequently, the first drive pin 51 drives the first drive shaft 5 to move along the thickness direction of the carriage 100, and the second drive pin 61 drives the second drive shaft 6 to move along the thickness direction of the carriage 100. Since the first drive shaft 5 is fixed to the first blade holder 3 and the second drive shaft 6 is fixed to the second blade holder 4, rotating the first knob 2 causes the first blade holder 3 and the second blade holder 4 to move along the thickness direction of the carriage 100. Thus, by rotating the first knob 2, the second cutting blade 190 can be moved along the thickness direction of the carriage 100.

In this embodiment, the first mounting holes 101 guide and limit the sliding of the first mounting portions 35 along the thickness direction of the carriage 100, enabling more reliable sliding. The second mounting holes 102 guide and limit the sliding of the second mounting portions 45 along the thickness direction of the carriage 100, enabling more reliable sliding. The first rectangular hole 131 guides and limits the movement of the first drive shaft 5 along the thickness direction of the carriage 100, and the second rectangular hole 141 guides and limits the movement of the second drive shaft 6 along the thickness direction of the carriage 100. The aforementioned guiding and limiting functions enable the second cutting blade 190 to move more reliably along the thickness direction of the carriage 100 and prevent the second cutting blade 190 from shaking due to food resistance during cutting, thereby improving cutting precision and stability and also avoiding damage to the first cutting blade 103 by the second cutting blade 190.

In this embodiment, when the second cutting blade 190 moves to the uppermost end of its travel along the thickness direction of the carriage 100, the tip of the second cutting blade 190 is positioned higher in the Z direction than the upper surface of the first cutting blade 103. Thus, a height difference exists in the Z direction between the tip of the second cutting blade 190 and the upper surface of the first cutting blade 103. This height difference causes the second cutting blade 190 to cut deeper strip-shaped gaps into the portion of the food it contacts. The roots of these strip-shaped gaps are then above the cutting plane of the first cutting blade 103. Consequently, when the first cutting blade 103 subsequently moves forward in the Y direction, it cuts off that portion of the food, thereby achieving the cutting of the food into strips and completing the cutting process.

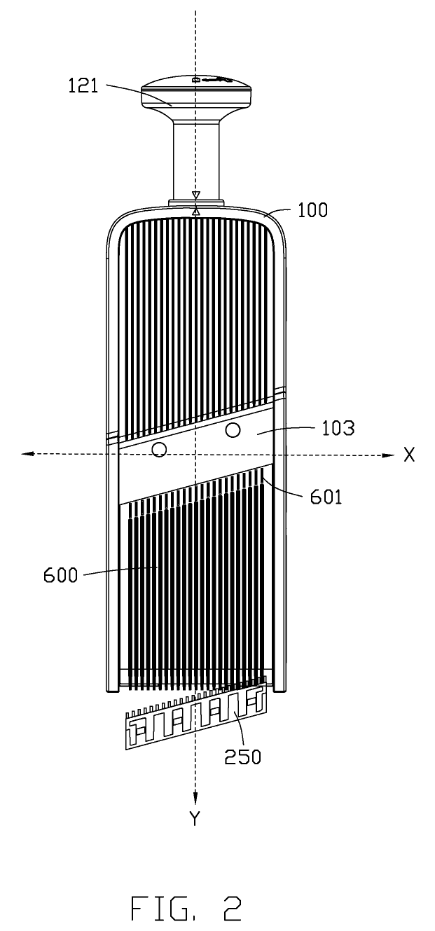

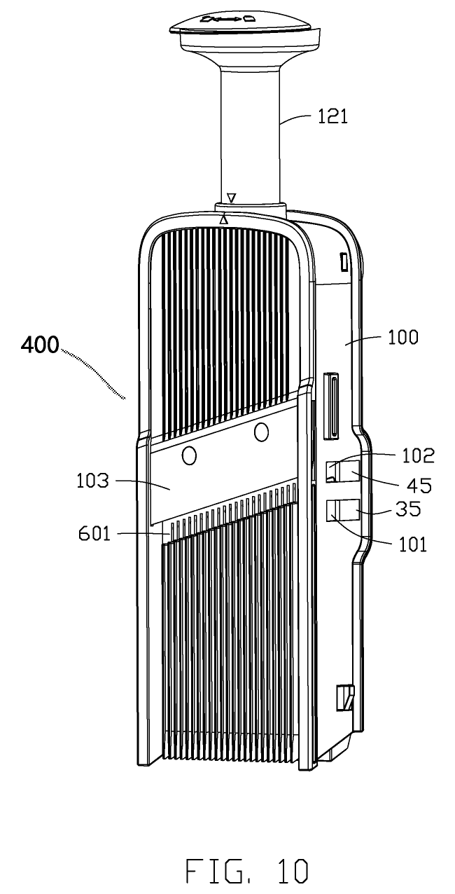

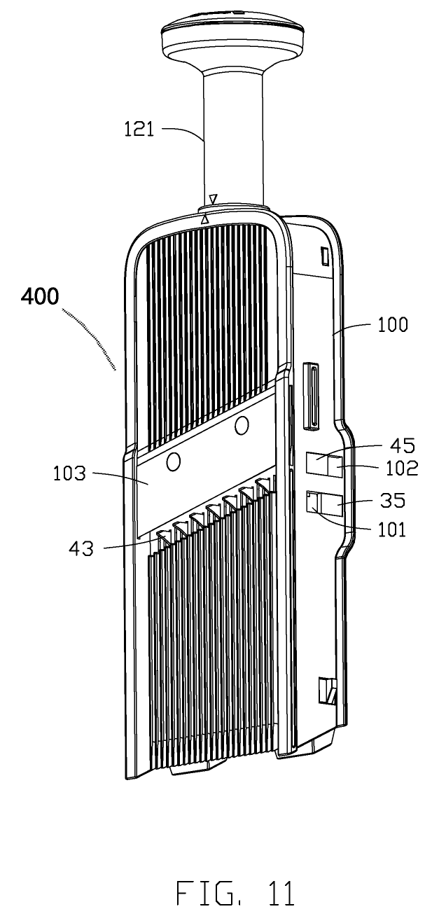

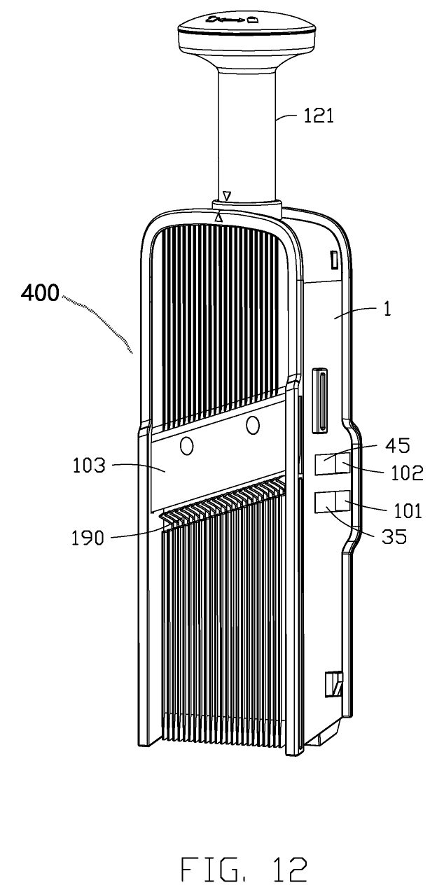

In this embodiment, referring to FIGS. 2-3 and 10-12, the carriage 100 is further provided with a thickness adjustment plate 600. The distance between the thickness adjustment plate 600 and the first cutting blade 103 in the thickness direction (Z direction) of the carriage100 is adjustable. The thickness of the food cut by the first cutting blade 103 is determined by the distance between the first cutting blade 103 and the thickness adjustment plate 600 in the Z direction. The thickness adjustment plate 600 is configured to cooperate with engaging teeth 250 provided on the housing 200, which are used to push the cut food toward the discharge outlet.

Specifically, the thickness adjustment plate 600 is provided with blade slots 601 through which the blades of the second cutting blade 190 protrude. The second cutting blade 190 has a cutting position and a retracted position. In the cutting position, the tips of the blades of the second cutting blade 190 protrude through the blade slots 601, thereby being higher than the upper surface of the first cutting blade 103. In the retracted position, the tips of the blades of the second cutting blade 190 are retracted within the blade slots 601. Thus, whether in the cutting position or the retracted position, the second cutting blade 190 does not disengage from the blade slots 601, preventing the problem of the second cutting blade 190 failing to align with the blade slots 601 when adjusting its position in the Z direction. Moreover, in the retracted position, unnecessary contact and collision between the second cutting blade 190 and food or other components are avoided, protecting the second cutting blade 190, prolonging its service life, and preventing the second cutting blade 190 from cutting a user when not in use.

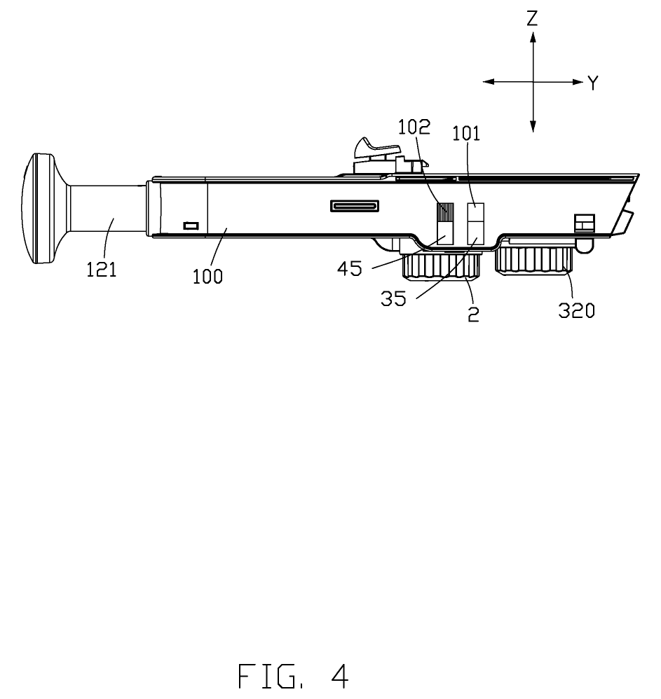

More specifically, referring to FIG. 4, when at least one of the first blade holder 3 and the second blade holder 4 is located at the uppermost end of its Z-direction travel, the second cutting blade 190 is in the cutting position. When both the first blade holder 3 and the second blade holder 4 are located at the lowermost ends of their Z-direction travel, the second cutting blade 190 is in the retracted position.

In this embodiment, by changing the Z-direction distance between the surface of the thickness adjustment plate 600 and the first cutting blade 103, the first cutting blade 103 can cut food into pieces of different thicknesses. When the second cutting blade 190 is in the cutting position, it cooperates with the first cutting blade 103 to cut food into strips or shreds. When the second cutting blade 190 is in the retracted position, it does not participate in cutting food, and the first cutting blade 103 slices the food.

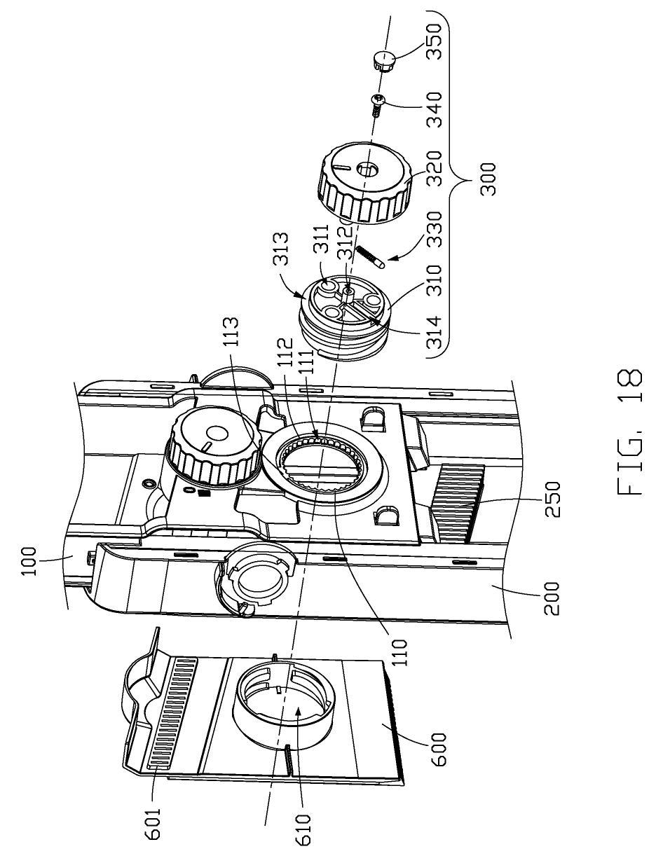

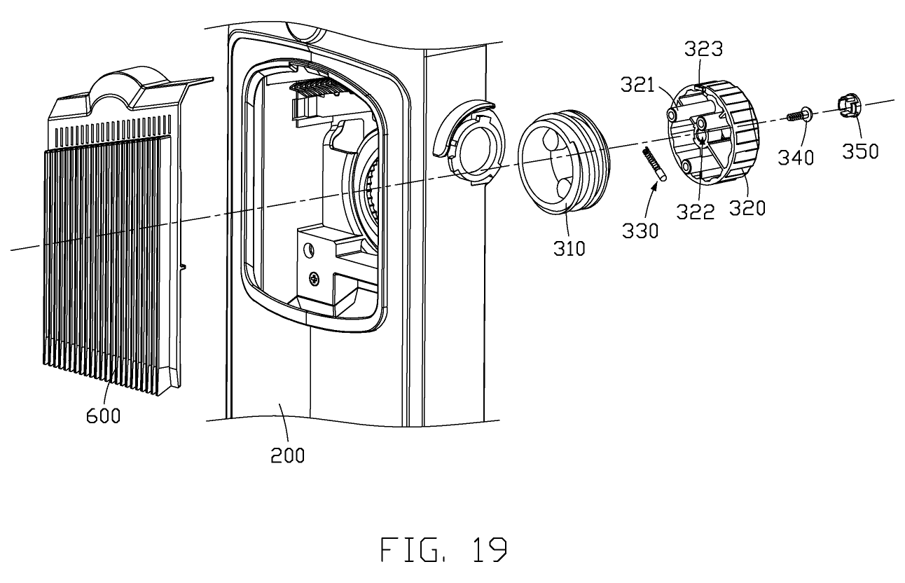

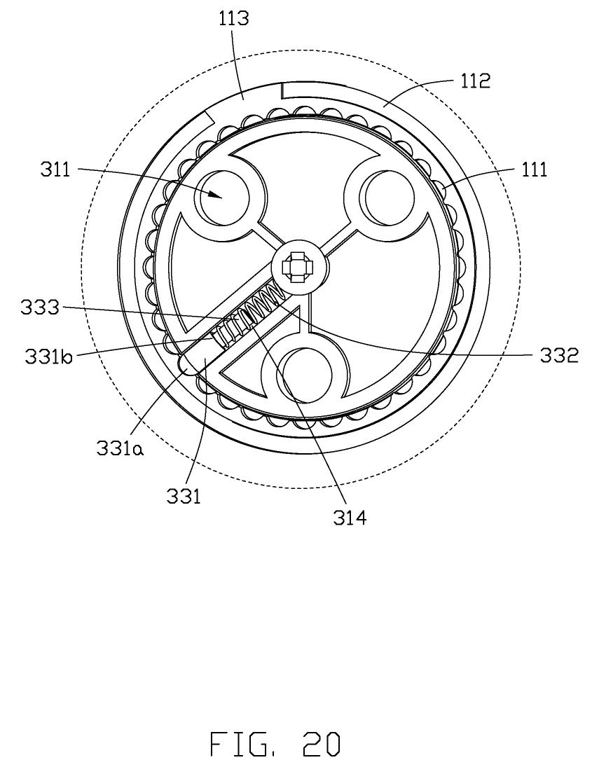

More specifically, a drive assembly 300 is threadedly connected to the thickness adjustment plate 600 for driving the thickness adjustment plate 600 to slide relative to the carriage 100. Referring to FIGS. 18-20, the drive assembly 300 includes a transmission member 310 and a second knob 320. The second knob 320 is located on the top surface of the transmission member 310. The back of the thickness adjustment plate 600 has a threaded hole 610. The transmission member 310 has an external thread that threadedly engages with the internal thread of the threaded hole 610. When the second knob 320 is rotated clockwise, the transmission member 310 rotates clockwise, and the thickness adjustment plate 600 moves in the thickness direction of the carriage 100 away from the first cutting blade 103, increasing the distance between the thickness adjustment plate 600 and the first cutting blade 103. At this time, the first cutting blade 103 can cut food into thicker pieces. When the second knob 320 is rotated counterclockwise, the thickness adjustment plate 600 moves in the thickness direction of the carriage 100 toward the first cutting blade 103, decreasing the distance between the thickness adjustment plate 600 and the first cutting blade 103. At this time, the first cutting blade 103 can cut food into thinner pieces.

Referring to FIGS. 18-20, to ensure a secure connection and effective transmission between the second knob 320 and the transmission member 310, the second knob 320 and the transmission member 310 are mutually interfitted and connected via a fastener. Specifically, three locating holes 311 are opened on the top surface of the transmission member 310. Correspondingly, three locating posts 321 adapted to the three locating holes 311 are provided on the back of the second knob 320. The locating posts 321 are inserted into the locating holes 311 to mutually interfitted the second knob 320 and the transmission member 310. In this embodiment, a first screw 340 is used as the fastener. The second knob 320 is provided with a first connection hole 322, and the transmission member 310 is provided with a second connection hole 312. The first screw 340 passes through the first connection hole 322 and the second connection hole 312 in sequence to connect the second knob 320 to the transmission member 310. The connection of the three locating holes 311 and locating posts 321 can restrict rotation between the second knob 320 and the transmission member 310, enabling the transmission member 310 to convert the rotation of the second knob 320 into the sliding of the thickness adjustment plate 600 relative to the carriage 100 via its threaded connection with the thickness adjustment plate 600. The screw connection ensures a firm connection between the second knob 320 and the transmission member 310, avoiding the failure of the connection due to aging of snap-fit connections common in the prior art. Additionally, the second knob 320 is further provided with a cover 350 capable of covering the first screw 340 to enhance the aesthetic appearance of the knob 320.

Referring to FIGS. 18-20, the top periphery of the transmission member 310 has a recessed step 313. The carriage 100 has an extension portion 110 that extends into the step 313 and confines the transmission member 310 within the carriage 100. The side surface of the extension portion 110 has a plurality of circumferentially arranged detent grooves 111. The drive assembly 300 further includes an elastic damping member 330 mounted on the transmission member 310 and elastically abutting the detent grooves 111. Specifically, the elastic damping member 330 includes a click pin 331 radially movably mounted on the transmission member 310, and an elastic element 332 acting between the click pin 331 and the transmission member 310. In this embodiment, the click pin 331 is a cylindrical body with a spherical end surface (a steel ball could also be used), and the elastic element 332 is a compression spring. The compression spring biases the head 331a of the click pin 331 to constantly tend to abut against the detent grooves 111. Thus, the elastic force of the compression spring acts on the click pin 331, causing its head 331a to constantly tend to abut against the detent grooves 111. Consequently, when the second knob 320 is rotated, the click pin 331 and the detent grooves 111 produce discontinuous frictional vibrations, increasing rotational damping and providing audible feedback, thereby improving the tactile feel during rotation of the second knob 320. Furthermore, radially arranging the click pin 331 allows for a reduction in the size of the second knob 320, making the food cutting device 1000 more compact. Moreover, the transmission member 310 is radially provided with a mounting groove 314 for accommodating the elastic damping member 330. A tail portion 331b of the click pin 331 extends locally outward to form a connecting portion 333. The compression spring is sleeved over the connecting portion 333, and its two ends respectively abut the tail portion 331b of the click pin 331 and the transmission member 310. The mounting groove 314 prevents the elastic element 332 or the click pin 331 from shifting when the second knob 320 rotates, increasing structural reliability.

Referring to FIGS. 18-20, to prevent the external thread of the transmission member 310 from stripping the internal thread of the threaded hole 610 due to excessive clockwise rotation of the second knob 320, or the transmission member 310 from disengaging from the threaded hole 610 due to excessive counterclockwise rotation, a limit block 323 extends downward from the bottom of the second knob 320. The extension portion 110 has an arcuate limit slot 112. The limit block 323 extends into the limit slot 112 and is slidably engaged therewith. A stop 113 is provided within the limit slot 112 to limit the limit block 323. The limit block 323 is constrained to slide within the limit slot 112, thereby restricting the rotational path of the second knob 320 and preventing deviation during rotation. The stop 113 restricts the rotation angle of the second knob 320, preventing excessive rotation.

More specifically, referring to FIG. 8, in this embodiment, the first knob 2 has a top wall 21 and a peripheral wall 22 located below the top wall 21. The top wall 21 is constrained on the carriage 100 and is rotatable about its own central axis. The peripheral wall 22 is rotatable together with the top wall 21. The first drive shaft 5 and the second drive shaft 6 are located within the space enclosed by the peripheral wall 22. The cam track 7 is located on the inner peripheral surface of the peripheral wall 22. The top wall 21 and the peripheral wall 22 are separate structures. The top wall 21 is sleeved on a boss 12 of the carriage 100 and is rotatable about the central axis of the boss 12. Additionally, a rib-and-groove interfitting structure is provided between the top wall 21 and the peripheral wall 22, enabling the peripheral wall 22 to rotate together with the top wall 21. Moreover, the top wall 21 is constrained onto the boss 12 by a second screw 900. After unscrewing the second screw 900, the first knob 2 can be removed from the carriage 100.

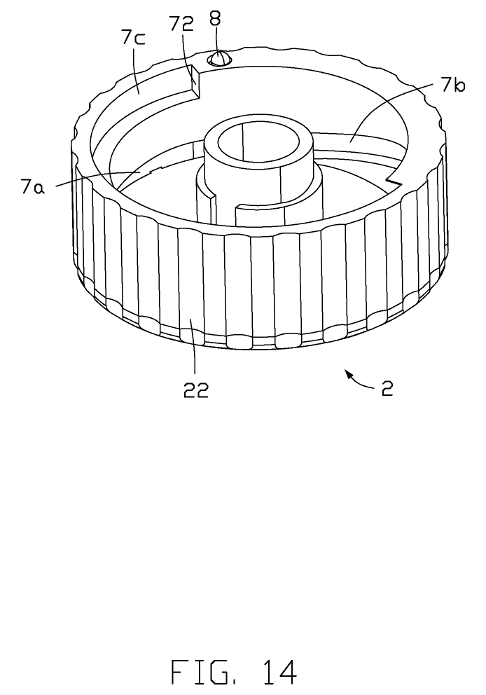

In this embodiment, referring to FIGS. 13 and 14, the cam track 7 includes three sections: a first arcuate track section 7a, a second arcuate track section 7c, and an inclined track section 7b. The first arcuate track section 7a and the second arcuate track section 7c are both arcuate (circular arc) tracks. The inclined track section 7b has a helical track. The first arcuate track section 7a is horizontally located at a first horizontal level. The second arcuate track section 7c is horizontally located at a second horizontal level. The inclined track section 7b connects the first arcuate track section 7a and the second arcuate track section 7c. More specifically, the upper end of the helical inclined track section 7b coincides with the end of the first arcuate track section 7a, and the lower end of the helical inclined track section 7b coincides with the end of the second arcuate track section 7c.

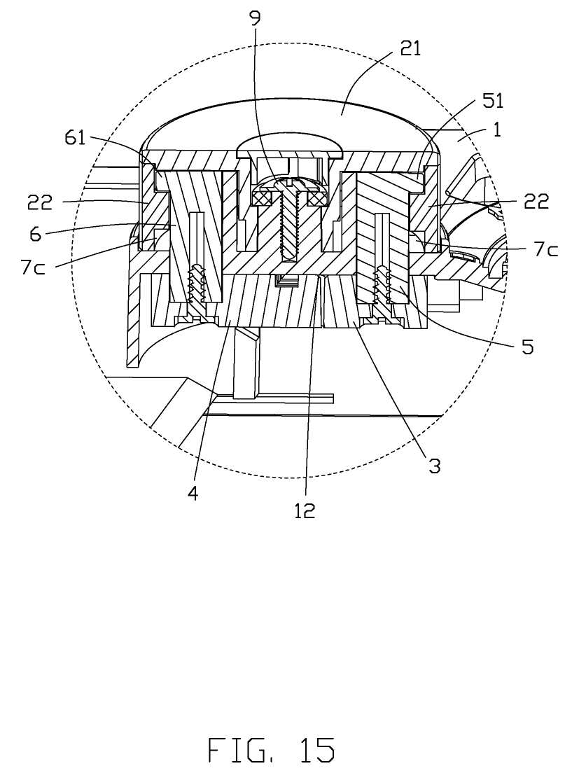

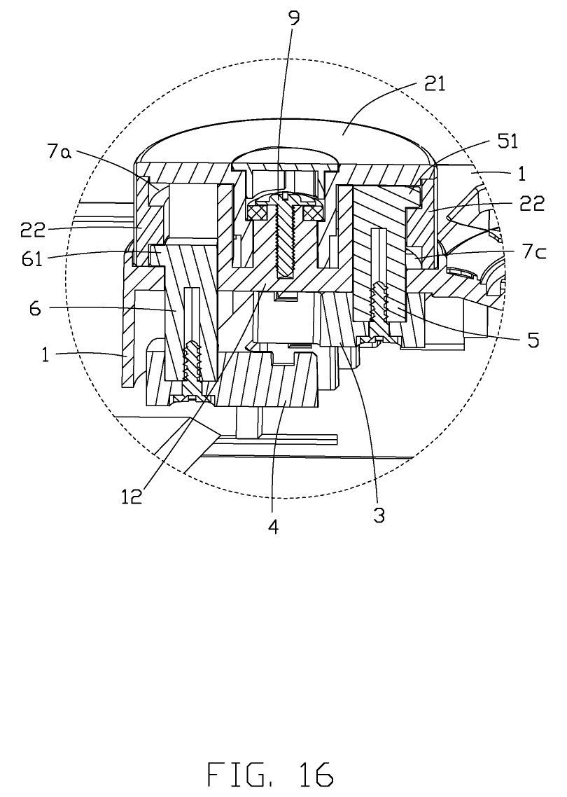

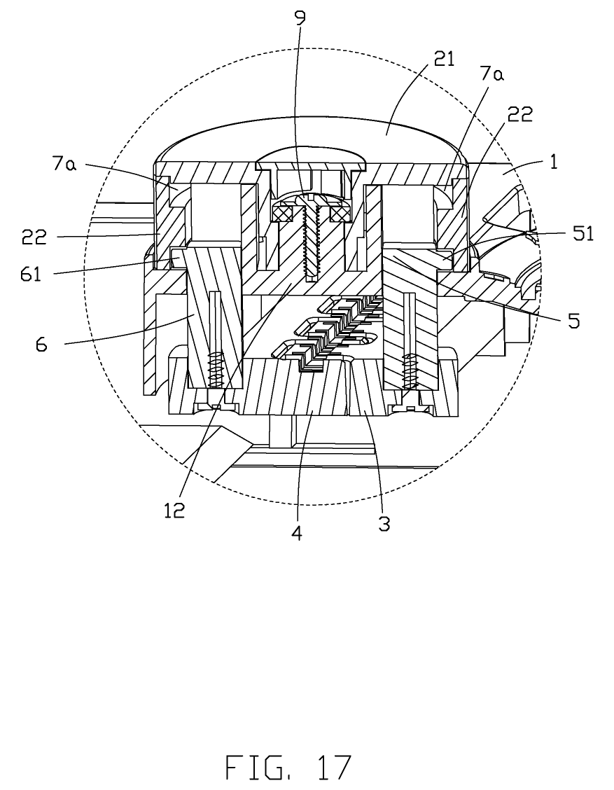

Depending on the rotation angle of the first knob 2, the first knob 2 has three gear positions (operating modes): a first gear, a second gear, and a third gear. Referring to FIG. 15, in the first gear state, both the first drive pin 51 and the second drive pin 61 are located in the first arcuate track section 7a. At this time, the second cutting blade 190 is in the retracted position, and the blades on the first blade holder 3 and the second blade holder 4 cannot cut food. Referring to FIG. 16, in the second gear state, the first drive pin 51 is located in the first arcuate track section 7a, and the second drive pin 61 is located in the second arcuate track section 7c. The second cutting blade 190 is in the cutting position, and the tips of the blades on the second blade holder 4 protrude through the blade slots, enabling the cutting of food into strips. Referring to FIG. 17, in the third gear state, both the first drive pin 51 and the second drive pin 61 are located in the second arcuate track section 7c. The second cutting blade 190 is also in the cutting position, and the tips of the blades on both the first blade holder 3 and the second blade holder 4 protrude through the blade slots, enabling the cutting of food into fine shreds.

More specifically, when the first knob 2 is rotated from the first gear to the second gear, the first drive pin 51 slides from the start end of the first arcuate track section 7a toward the end of the first arcuate track section 7a, and the second drive pin 61 slides from the end of the first arcuate track section 7a via the helical inclined track section 7b toward the end of the second arcuate track section 7c. When the first knob 2 is rotated from the second gear to the third gear, the first drive pin 51 slides via the helical inclined track section 7b from the end of the first arcuate track section 7a toward the end of the second arcuate track section 7c, and the second drive pin 61 slides from the end of the second arcuate track section 7c toward the start end of the second arcuate track section 7c. Because the first arcuate track section 7a and the second arcuate track section 7c are horizontal tracks, when the first drive pin 51 and the second drive pin 61 slide within these sections, the first blade holder 3 and the second blade holder 4 do not move relative to the carriage 100 in the thickness direction. Because the inclined track section 7b is helical, when the first drive pin 51 or the second drive pin 61 slides within it, the respective blade holder moves relative to the carriage 100 in the thickness direction. Since the first drive pin 51 and the second drive pin 61 do not slide into the helical inclined track section 7b simultaneously, the first blade holder 3 and the second blade holder 4 can move asynchronously along the thickness direction of the carriage 100.

In this embodiment, rotating the first knob 2 clockwise sequentially changes the gear positions from first gear to second gear to third gear. Rotating the first knob 2 counterclockwise sequentially changes the gear positions from third gear to second gear to first gear. To facilitate positioning during gear adjustment, a first stop wall 71 is provided at the start end of the first arcuate track section 7a. In the first gear state, the first stop wall 71 blocks the first drive pin 51, such that the first drive pin 51 can only slide toward the inclined track section 7b. A second stop wall 72 is provided at the end of the second arcuate track section 7c. In the third gear state, the second stop wall 72 blocks the second drive pin 61, such that the second drive pin 61 can only rotate toward the inclined track section 7b.

Additionally, referring to FIG. 8, to enable positioning at each gear position when the first knob 2 is rotated, the first knob 2 is provided with a positioning member 8 biased by a spring. The surface of the carriage 100 is provided with recesses 11 corresponding to the three gear positions. When the first knob 2 is rotated to the corresponding gear position, the positioning member 8 is received in the corresponding recess 11. Thus, when the first knob 2 is rotated to a gear position, the entry of the positioning member 8 into the corresponding recess 11 generates frictional vibration, enhancing the tactile feel during rotation of the first knob 2. The spring-biased positioning member 8 increases the rotational damping of the first knob 2, further improving the tactile feel.

More specifically, the gear adjustment process of this embodiment is as follows:

First Gear: The first drive pin 51 is at the start end of the first arcuate track section 7a, and the second drive pin 61 is at the end of the first arcuate track section 7a. At this time, the blades on the first blade holder 3 and the second blade holder 4 do not protrude from the blade slots 601.

Switching from First Gear to Second Gear: Rotate the first knob 2 clockwise. The first drive pin 51 slides from the start end of the first arcuate track section 7a to the end of the first arcuate track section 7a. The second drive pin 61 slides via the inclined track section 7b to the start end of the second arcuate track section 7c. At this time, the blades on the first blade holder 3 do not protrude from the blade slots 601, while the blades on the second blade holder 4 protrude from the blade slots 601.

Switching from Second Gear to Third Gear: Rotate the first knob 2 clockwise. The first drive pin 51 slides via the inclined track section 7b to the start end of the second arcuate track section 7c. The second drive pin 61 slides from the start end of the second arcuate track section 7c to the end of the second arcuate track section 7c. At this time, the blades on both the first blade holder 3 and the second blade holder 4 protrude from the blade slots 601.

Switching from Third Gear to Second Gear: Rotate the first knob 2 counterclockwise. The first drive pin 51 slides via the inclined track section 7b to the end of the first arcuate track section 7a. The second drive pin 61 slides from the end of the second arcuate track section 7c to the start end of the second arcuate track section 7c. At this time, the blades on the first blade holder 3 retract into the blade slots 601, while the blades on the second blade holder 4 remain protruding from the blade slots.

Switching from Second Gear to First Gear: Rotate the first knob 2 counterclockwise. The first drive pin 51 slides from the end of the first arcuate track section 7a to the start end of the first arcuate track section 7a. The second drive pin 61 slides via the inclined track section 7b to the end of the first arcuate track section 7a. At this time, the blades on both the first blade holder 3 and the second blade holder 4 retract into the blade slots 601.

### Embodiment 2

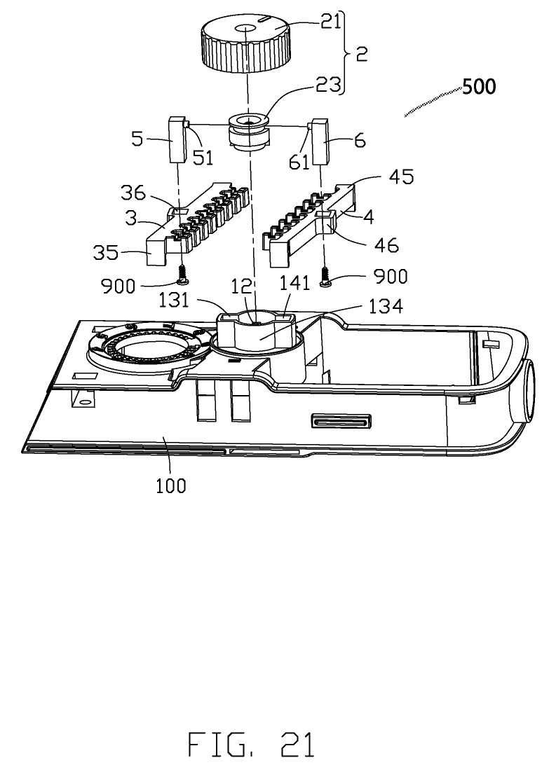

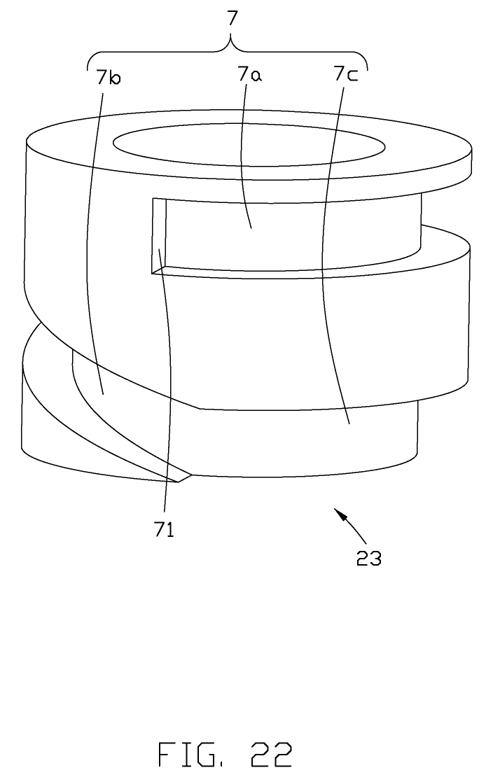

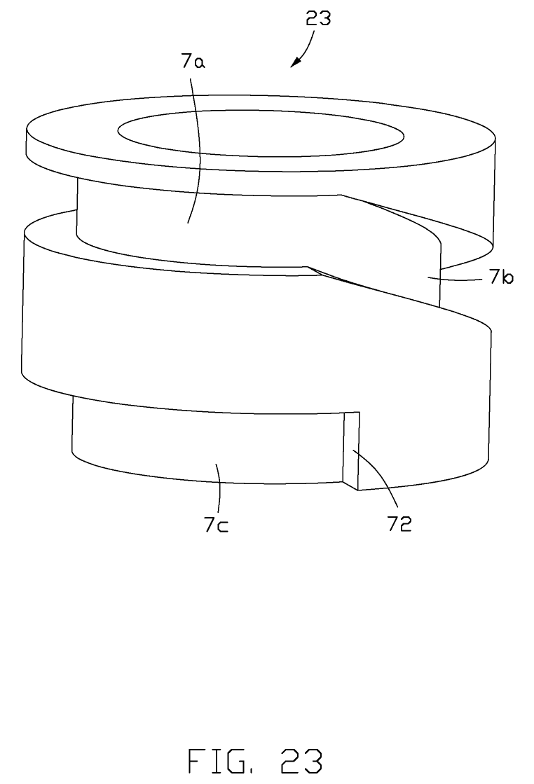

Referring to FIGS. 21-26, the first knob 2 of this embodiment has a top wall 21 and a transmission column 23 connected to the bottom surface of the top wall 21. The transmission column 23 is rotatable together with the top wall 21. The transmission column 23 is located between the first drive shaft 5 and the second drive shaft 6. The cam track 7 is located on the outer peripheral surface of the transmission column 23.

To facilitate the molding of the cam track 7, the top wall 21 and the transmission column 23 are two separate components. The bottom surface of the top wall 21 has a sleeve portion 24 extending downward. The sleeve portion 24 is sleeved on the boss 12 of the carriage 100 and is rotatable. The transmission column 23 is sleeved on the outer periphery of the sleeve portion 24. A keyway structure is provided between the inner peripheral surface of the transmission column 23 and the outer peripheral surface of the sleeve portion 24. The transmission column 23 and the sleeve portion 24 are interfitted via the keyway structure, so that when the adjustment knob 2 is rotated, the transmission column 23 rotates together with the first knob 2.

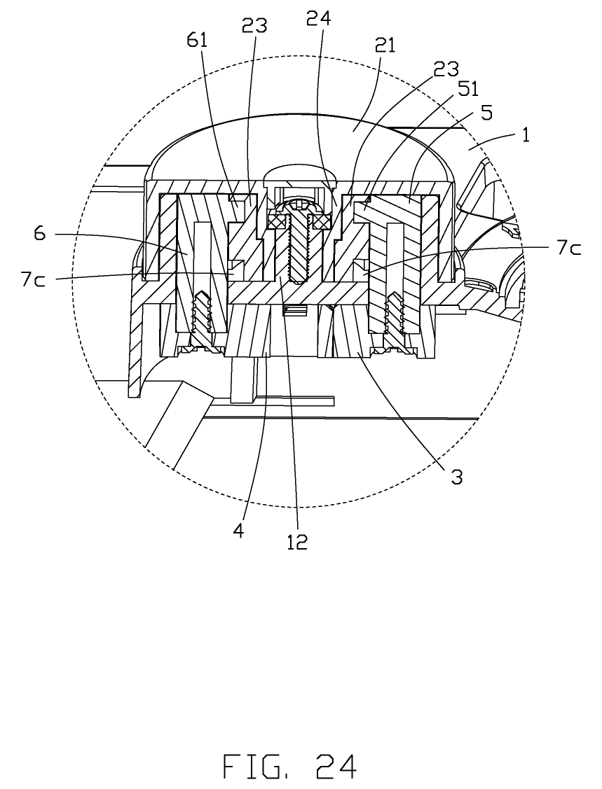

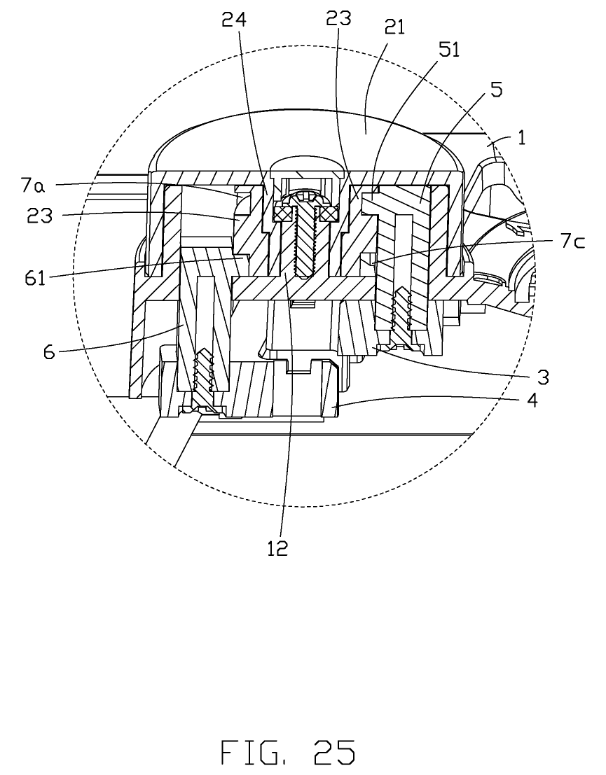

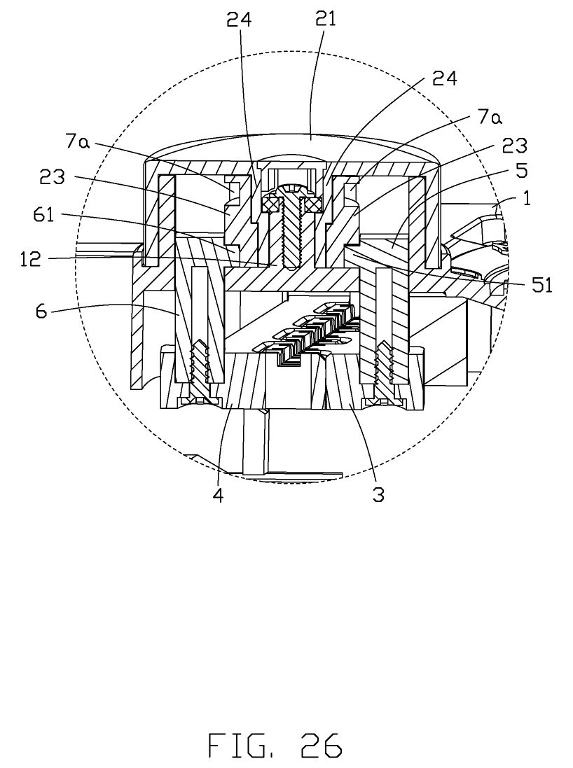

In this embodiment, referring to FIG. 24, a half cross-sectional schematic diagram of the first knob 2 in the first gear state is shown. At this time, the first drive pin 51 and the second drive pin 61 are located in the first arcuate track section 7a. Referring to FIG. 25, in the second gear state of the first knob 2, the first drive pin 51 is located in the first arcuate track section 7a, and the second drive pin 61 is located in the second arcuate track section 7c. Referring to FIG. 26, in the third gear state of the first knob 2, both the first drive pin 51 and the second drive pin 61 are located in the second arcuate track section 7c.

Clearly, the embodiments described above are only part of the embodiments of this application, not all of them. The drawings show relatively good embodiments of this application but do not limit the patent scope of this application. This application can be implemented in many different forms. On the contrary, the purpose of providing these embodiments is to make the understanding of the disclosure of this application more thorough and comprehensive.

Furthermore, persons of ordinary skill in the art should understand that the above embodiments are only used to illustrate this application and are not intended to limit this application. As long as in the essential spirit and scope of this application, appropriate changes and modifications to the above embodiments fall in the scope of disclosure of this application.

What is claimed is:

1. A food cutting device, comprising:
a housing;
a carriage, slidably engaged with the housing;
a first blade holder mounted on the carriage and movable relative to the carriage in a thickness direction of the carriage, and
the first blade holder comprising a plurality of first protrusions spaced apart from each other, each of the plurality of first protrusions comprising a first blade;
a second blade holder mounted on the carriage and movable relative to the carriage in the thickness direction, and
the second blade holder comprising a plurality of second protrusions spaced apart from each other, each of the plurality of second protrusions comprising a second blade, wherein the plurality of second protrusions interleave with the plurality of first protrusions;
a first drive shaft fixedly connected to the first blade holder, and the first drive shaft comprising a first drive pin;
a second drive shaft fixedly connected to the second blade holder, and the second drive shaft comprising a second drive pin; and
a first knob rotatably mounted on the carriage, and
the first knob comprising a cam track slidably engaging the first drive pin and the second drive pin, wherein the first drive pin and the second drive pin are located within the cam track;
wherein a shape of the cam track is shaped such that, when the first knob is rotated, the first drive pin and the second drive pin are capable of being positioned at different horizontal levels in the cam track, causing the first blades and the second blades to move asynchronously in the thickness direction of the carriage.

2. The food cutting device according to claim 1, wherein
the cam track comprises three sections:
a first arcuate track section located at a first horizontal level;
a second arcuate track section located at a second horizontal level; and
an inclined track section connecting the first arcuate track section and the second arcuate track section.

3. The food cutting device according to claim 2, wherein
the inclined track section has a helical track.

4. The food cutting device according to claim 3, wherein
the first knob is configured to be selectively positioned in three gear positions corresponding to different rotation angles of the first knob, the three gear positions comprising a first gear, a second gear, and a third gear, wherein
in the first gear, both the first drive pin and the second drive pin are located in the first arcuate track section;
in the second gear, the first drive pin is located in the first arcuate track section and the second drive pin is located in the second arcuate track section; and
in the third gear, both the first drive pin and the second drive pin are located in the second arcuate track section.

5. The food cutting device according to claim 4, wherein
the cam track is configured such that:
in response to the first knob is rotated from the first gear toward the second gear, the first drive pin slides from a start end toward an end of the first arcuate track section, and the second drive pin slides from the end of the first arcuate track section, via the helical track, toward an end of the second arcuate track section;
in response to the first knob is rotated from the second gear toward the third gear, the first drive pin slides from the end of the first arcuate track section, via the helical track, toward the end of the second arcuate track section, and the second drive pin slides from the end toward a start end of the second arcuate track section, wherein
the end of the first arcuate track section coincides with an upper end of the helical track, and the end of the second arcuate track section coincides with a lower end of the helical track.

6. The food cutting device according to claim 5, further comprising:
a first stop wall disposed at the start end of the first arcuate track section; and
a second stop wall disposed at the start end of the second arcuate track section, wherein
in the first gear, the first stop wall blocks the first drive pin; and
in the third gear, the second stop wall blocks the second drive pin.

7. The food cutting device according to claim 3, wherein
the first knob comprises a top wall and a peripheral wall disposed below the top wall;
the top wall is constrained on the carriage and rotatable about an axis of the top wall;
the peripheral wall is rotatable together with the top wall;
the first drive shaft and the second drive shaft are located in a space enclosed by the peripheral wall; and
the cam track is disposed on an inner peripheral surface of the peripheral wall.

8. The food cutting device according to claim 7, wherein
the top wall is sleeved on a boss of the carriage;
the first knob is rotatable about the boss; and
the first knob is constrained on the boss by a screw.

9. The food cutting device according to claim 3, wherein
the first knob comprises a top wall and a transmission column located on a bottom surface of the top wall;
the transmission column is rotatable together with the top wall;
the transmission column is located between the first drive shaft and the second drive shaft; and
the cam track is located on an outer peripheral surface of the transmission column.

10. The food cutting device according to claim 1, wherein
opposite sides of the carriage comprises first mounting holes, respectively, and opposite ends of the first blade holder comprise first mounting portions, respectively;
the first mounting portions are respectively located within the first mounting holes and slidable in the first mounting holes in the thickness direction of the carriage;
opposite sides of the carriage further comprising second mounting holes adjacent the first mounting holes, and opposite ends of the second blade holder comprise second mounting portions, respectively;
the second mounting portions are respectively located within the second mounting holes and slidable in the second mounting hole in the thickness direction of the carriage.

11. The food cutting device according to claim 9, wherein
the bottom surface of the top wall further comprises a sleeve portion extending downward;
the sleeve portion is sleeved on a boss of the carriage, the first knob is rotatable about the boss; and
the transmission column is sleeved on an outer periphery of the sleeve portion.

12. The food cutting device according to claim 11, further comprising:
a keyway structure between an inner peripheral surface of the transmission column and an outer peripheral surface of the sleeve portion, wherein:
the transmission column and the sleeve portion are interfitted via the keyway structure such that, in response to the first knob been rotated, the transmission column rotates together with the first knob.

13. The food cutting device according to claim 4, wherein
the first knob comprises a spring-biased positioning member; and
a surface of the carriage comprises recesses corresponding to the three gear positions;
the positioning member is received in a corresponding recess in response to the first knob is rotated to a respective gear position of the three gear positions.

14. The food cutting device according to claim 1, wherein
each of the plurality of first protrusions of the first blade holder has two first insertion slots configured for receiving a corresponding first blade of the plurality of first blades; and
each of the plurality of second protrusions of the second blade holder has a second insertion slot configured for receiving a corresponding second blade of the plurality of second blades, and
the plurality of second protrusions interfits with the plurality of first protrusions in an alternating arrangement.

15. The food cutting device according to claim 14, wherein
the first blade on the first blade holder has cutting edges on a front side and a rear side of the first blade, and the second blade on the second blade holder has cutting edges on a front side and a rear side of the second blade.

16. The food cutting device according to claim 10, further comprising
a thickness adjustment plate movably engaged with the carriage, and
the thickness adjustment plate comprising blade slots configured for cutting edges of the first blade on the first blade holder and cutting edges of the second blade on the second blade holder to pass through; and
a drive assembly comprising
a second knob; and
a transmission member, wherein the second knob is interfitted and connected with the transmission member, and the transmission member is threadedly connected to the thickness adjustment plate;
in response to the second knob been rotated, the thickness adjustment plate slides in the thickness direction of the carriage.

17. The food cutting device according to claim 16, wherein
a top periphery of the transmission member comprises a recessed step; and
the carriage comprises an extension portion extending into the recessed step and confining the transmission member within the carriage;
the extension portion comprises at least two circumferentially arranged detent grooves; and
the drive assembly further comprises an elastic damping member disposed on the transmission member and elastically abutting the at least two circumferentially arranged detent grooves.

18. The food cutting device according to claim 17, wherein
the at least two circumferentially arranged detent grooves are located on a side surface of the extension portion;
the elastic damping member comprises:
a click pin radially movably mounted on the transmission member; and
an elastic element resisting between the click pin and the transmission member, the elastic element configured to bias a head of the click pin to constantly abut against the at least two circumferentially arranged detent grooves.

19. The food cutting device according to claim 18, wherein
the transmission member has a mounting groove extending radially and receiving the elastic damping member;
a tail portion of the click pin extends outward to form a connecting portion; and
the elastic element is a spring sleeved over the connecting portion, opposite ends of the spring respectively abutting the tail portion of the click pin and the transmission member.

20. The food cutting device according to claim 19, further comprising:
a limit block extending downward from a bottom of the second knob;
the extension portion comprising an arcuate limit slot, wherein:
the limit block extends into the limit slot and is slidably engaged with the limit slot.

21. A food cutting device, comprising
a housing;
a carriage, movable relative to the housing;
a first blade holder comprising a first blade set;
a second blade holder comprising a second blade set;
a first drive shaft fixedly connected to the first blade holder, and the first drive shaft comprising a first drive pin;
a second drive shaft fixedly connected to the second blade holder, and the second drive shaft comprising a second drive pin; and
a first knob rotatably mounted on the carriage, the first knob comprising a cam track slidably engaging the first drive pin and the second drive pin;
in response to the first knob been rotated, the first blade set and the second blade set move asynchronously in a thickness direction of the carriage.

22. The food cutting device according to claim 21, wherein
the cam track comprises three interconnected sections:
a first arcuate track section located at a first horizontal level;
a second arcuate track section located at a second horizontal level; and
a helical track section connecting the first arcuate track section and the second arcuate track section.

23. The food cutting device according to claim 22, wherein
the first drive shaft and the second drive shaft are arranged opposite to each other.

24. The food cutting device according to claim 21, wherein
the first knob comprises a top wall and a peripheral wall disposed below the top wall;
the top wall is constrained on the carriage and rotatable about an axis of the top wall;
the peripheral wall is rotatable together with the top wall;
the first drive shaft and the second drive shaft are located within a space enclosed by the peripheral wall; and
the cam track is located on an inner peripheral surface of the peripheral wall.

25. The food cutting device according to claim 24, wherein
the top wall and the peripheral wall are separate structures.

26. The food cutting device according to claim 21, wherein
the first knob comprises a top wall and a transmission column disposed on a bottom surface of the top wall;
the transmission column is rotatable together with the top wall;
the transmission column is located between the first drive shaft and the second drive shaft; and
the cam track is disposed on an outer peripheral surface of the transmission column.

27. The food cutting device according to claim 26, wherein
the top wall and the transmission column are separate structures.

28. A food cutting device, comprising
a carriage, having a first drive shaft and a second drive shaft located on the carriage, a first drive shaft and a second drive shaft configured for moving linearly in a common direction, wherein:
a side surface of the first drive shaft comprising a protruding first drive pin, a side surface of the second drive shaft comprising a protruding second drive pin;
the food cutting device further comprising a first blade holder fixedly connected to the first drive shaft, the first blade holder comprising a first blade set;
a second blade holder fixedly connected to the second drive shaft, the second blade holder comprising a second blade set, wherein the first blade set is parallel to the second blade set; and
a first knob rotatably mounted on the carriage, and the first knob comprising a cam track slidably engaging the first drive pin and the second drive pin;
in response to the first knob been rotated, the first drive pin and the second drive pin are driven to slide along the cam track, causing the first blade set and the second blade set to move linearly and asynchronously in a thickness direction of the carriage.

29. The food cutting device according to claim 28, wherein
the first drive pin and the second drive pin are arranged opposite to each other.

30. The food cutting device according to claim 28, wherein
the first blade set comprises cutting edges on a front side and a rear side of the first blade set; and the second blade set comprises cutting edges on a front side and a rear side of the second blade set, and
in the thickness direction of the carriage, a height of the front cutting edges is greater than a height of the rear cutting edges.
